(19) United States
(12) Patent Application Publication
(10) Pub. No.: US 2026/0204269 A1
(43) Pub. Date: Jul. 16, 2026

(54) IMPROVED TRANSITIONS IN A MULTI-MODE AUDIO DECODER

(71) Applicant: Telefonaktiebolaget LM Ericsson (publ), Stockholm (SE)

(72) Inventors: Sumeyra Ummuhan DEMIR KANIK, Sundbyberg (SE); Erik NORVELL, Upplands Väsby (SE)

(73) Assignee: Telefonaktiebolaget LM Ericsson (publ), Stockholm (SE)

(21) Appl. No.: 19/138,798

(22) PCT Filed: Dec. 12, 2023
(86) PCT No.: PCT/EP2023/085308

§ 371 Date: Jun. 13, 2025

Related U.S. Application Data
(60) Provisional application No. 63/432,131, filed on Dec. 13, 2022.

(51) Int. Cl. G10L 19/08; G10L 19/02

(52) U.S. Cl. CPC G10L 19/08; G10L 19/02

(57) ABSTRACT

According to a seventh aspect there is presented a decoder to decode an encoded audio frame, the audio frame being encoded using one of at least two modes. The decoder is configured to receive information indicating a selected coding mode and to determine whether the selected coding mode is a first mode, and responsive to determining that the selected coding mode is the first mode, determine whether a previous coding mode is the first mode. Responsive to the selected coding mode being the first mode and the previous coding mode not being the first mode, the decoder estimates an envelope stability measure using an energy stability and a shape stability of a previous frame. The encoded audio frame is decoded using the estimated envelope stability measure, and an energy stability of a current frame and a shape stability of a current frame is determined.

### TECHNICAL FIELD

The present disclosure relates generally to communications, and more particularly to communication methods and related devices and nodes supporting wireless communications.

### BACKGROUND

Modern audio codecs are designed to compress a wide variety of input audio signals. For low bit rate encoding, it has proven beneficial to utilize several audio coding methods intended to handle different types of audio signals. Each audio coding method corresponds to a specific operation mode of the audio encoder, hence the term multi-mode audio encoder. For instance, speech signals are often encoded using a speech model-based coding mode such as Algebraic Code Excited Linear Prediction (ACELP), while general audio signals like music is better captured using a transform-based coding mode such as the Modified Discrete Cosine Transform (MDCT) based Transform Coded Residual (TCX). There are several examples of audio codecs based on this principle, such as 3GPP 26.290 AMR-WB+, ISO/IEC 23003-3 MPEG-D USAC and 3GPP 26.445 EVS.

There currently exist certain challenge(s). A challenge for multi-mode audio codecs is handling the transition between different coding modes. Although the coding modes handle their designated audio signal type very well, they may exhibit a particular signature or type of distortion, and the difference in signature between coding modes becomes apparent when switching between modes. Therefore, handling the transition between modes is an essential task in a multi-mode audio codec. Since the coding modes are inherently different, they also contain different signal processing tools which may include memories of past encoded audio. When switching between modes, these memories require reinitialization to avoid the old or outdated memories that are used after the transition.

### SUMMARY

One solution would be to run all the encoding modes in parallel, thereby keeping all the encoding modes and their memories up to date. However, in most cases this solution would be computationally too complex.

Another challenge is that the memories or states of a certain coding mode may not be present in the other coding modes. Performing the required analysis to keep the memories updated may also require a high computational effort.

Certain aspects of the disclosure and their embodiments may provide solutions to these or other challenges. Various embodiments initialize an envelope stability parameter in one encoding mode upon coding mode switch based on a low-complex analysis run in other encoding modes. The low-complex analysis contains but is not limited to an energy analysis and a spectral shape analysis. The result of the low-complex analysis is used when switching to said encoding mode to initialize a critical memory of the coding mode.

According to a first aspect there is presented a method in a decoder to decode an encoded audio frame, the audio frame being encoded using one of at least two modes. The method comprises receiving information indicating a selected coding mode and determining whether the selected coding mode is a first mode. Responsive to determining that the selected coding mode is the first mode, determining whether a previous coding mode is the first mode. Responsive to the selected coding mode being the first mode and the previous coding mode not being the first mode, estimating an envelope stability measure using an energy stability and a shape stability of a previous frame. Decoding the encoded audio frame using the estimated envelope stability measure, and determining an energy stability of a current frame and a shape stability of a current frame.

According to a second aspect there is presented a method in a decoder to decode an encoded audio encoded using multiple modes. The method comprises receiving information indicating a selected coding mode and determining whether a current mode is a first mode and a previous mode is not the first mode. Responsive to the determining being yes, estimating an envelope stability measure using an energy stability and a shape stability of a previous frame. Decoding the encoded audio frame based on the current mode, and determining an energy stability of a current frame and a shape stability of a current frame.

According to a third aspect there is presented a decoder to decode an encoded audio encoded using multiple modes, the decoder being adapted to perform the method in accordance with the first or the second aspect.

According to a fourth aspect there is presented a decoder to decode an encoded audio encoded using multiple modes. The decoder comprises processing circuitry and memory coupled with the processing circuitry, wherein the memory includes instructions that when executed by the processing circuitry causes the decoder to perform operations in accordance with the first or the second aspect.

According to a fifth aspect there is presented a computer program comprising program code to be executed by processing circuitry of a decoder, whereby execution of the program code causes the decoder to perform operations in accordance with the first or the second aspect.

According to a sixth aspect there is presented a computer program product comprising a non-transitory storage medium including program code to be executed by processing circuitry of a decoder, whereby execution of the program code causes the decoder to perform operations in accordance with the first or the second aspect.

According to a seventh aspect there is presented a decoder to decode an encoded audio frame, the audio frame being encoded using one of at least two modes. The decoder is configured to receive information indicating a selected coding mode, and to determine whether the selected coding mode is a first mode. Responsive to determining that the selected coding mode is the first mode, the decoder is configured to determine whether a previous coding mode is the first mode. Responsive to the selected coding mode being the first mode and the previous coding mode not being the first mode, the decoder is configured to estimate an envelope stability measure using an energy stability and a shape stability of a previous frame. The encoded audio frame is decoded using the estimated envelope stability measure, and an energy stability of a current frame and a shape stability of a current frame is determined.

Certain embodiments may provide one or more of the following technical advantage(s). Advantages that may be achieved include improved transitions between the modes of a multi-mode decoder since the memories are kept updated during transitions between modes. The advantages may be achieved with a small impact on the computational complexity.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an example of an operating environment in which the various embodiments of the present disclosure may be implemented according to some embodiments;

FIG. 2 is an illustration of a sigmoid function according to some embodiments;

FIG. 3 is a block diagram of a decoder according to some embodiments of the present disclosure;

FIG. 4 is a block diagram illustrating additional details of the decoder of FIG. 3 according to some embodiments of the present disclosure;

FIGS. 5-6 are flow charts illustrating operations of a decoder according to some embodiments of the present disclosure;

FIG. 7 is a block diagram of a user equipment in accordance with some embodiments;

FIG. 8 is a block diagram of a host computer communicating with a user equipment in accordance with some embodiments; and

FIG. 9 is a block diagram of a virtualization environment in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, a challenge for multi-mode audio codecs is handling the transition between different coding modes. Although the coding modes handle their designated audio signal type very well, they may exhibit a particular signature or type of distortion, and the difference in signature between coding modes becomes apparent when switching between modes. Therefore, handling the transition between modes is an essential task in a multi-mode audio codec. Since the coding modes are inherently different, they also contain different signal processing tools which may include memories of past encoded audio. When switching between modes, these memories require reinitialization to avoid the old or outdated memories that are used after the transition.

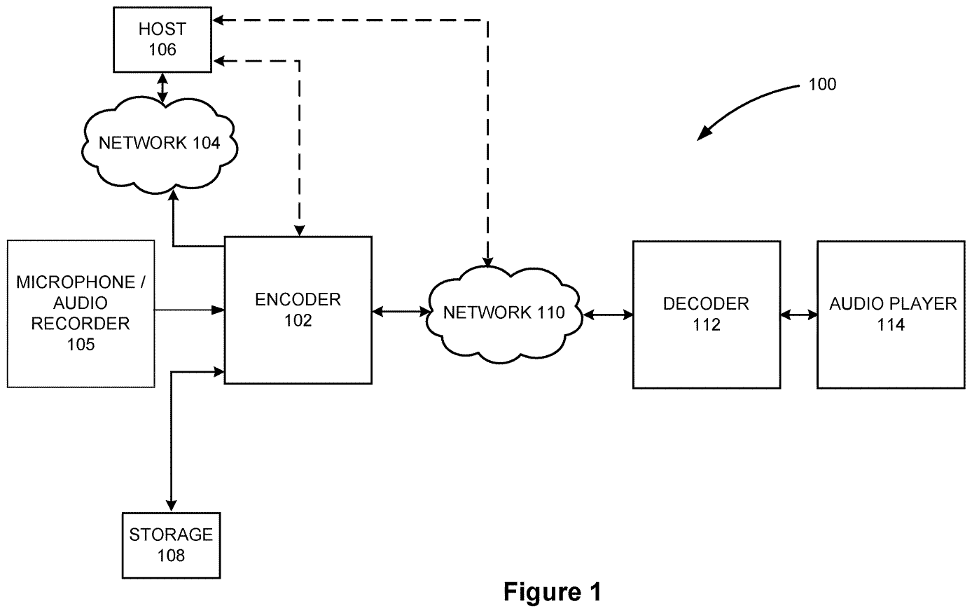

Prior to describing the embodiments that address the challenge, an example of an operating environment shall be described. FIG. 1 illustrates an example of an operating environment in which the various embodiments of the present disclosure may be implemented. Turning to FIG. 1, in the example operating environment 100, the encoder 102 receives data, such as an audio file, to be encoded from an entity through network 104, such as a host 106, from storage 108, and/or from an audio recorder in connection with a microphone 105. In some embodiments, the host 106 may communicate directly to the encoder 102 and contain an audio recorder 105. The encoder 102 encodes the audio file as described herein and either stores the encoded audio file in storage 108 or transmits the encoded audio file to a decoder 112 via network 110. The decoder 112 decodes the audio file and transmits the decoded audio file to an audio player 114 for playback. The audio player 114 may be or be comprised in a user equipment, a terminal, a mobile phone, and the like. In other embodiments, the host 106 may transmit encoded audio files to the decoder 112 via network 110.

An audio coding system consists of two main parts, an audio encoder 102 and decoder 112. The input audio is processed in time segments called frames x(m, n) consisting of samples n=0, 1, 2, . . . L−1 in frame m. The frames may be extracted with an overlap, such that the analysis frame is longer than the output synthesis of each frame. Depending on the properties of the audio signal in frame x(m, n), a coding mode is selected to encode it. The mode selection can be done either by using a signal classifier to decide which coding mode would obtain the best performance, or in a so-called closed loop fashion where all available coding modes are run, and the best performing mode is selected.

Three encoding modes will be used to describe the various embodiments and are denoted as Mode A, Mode B, and Mode C.

Mode A—Modified Discrete Cosine Transform (MDCT) based coding mode.

In this mode, the input frame x(m, n) is transformed to the Modified Discrete Cosine Transform domain by means of the following equation:

$$X ( m , k ) = {\sum }_{n = 0}^{2 L - 1} x ( m , n ) {w}_{a} ( n ) cos ( \frac{π}{L} + \frac{1}{2} + \frac{L}{2} ) ( k + \frac{1}{2} )$$

where wₐ(n) is the analysis window.

It should be noted that the frame length used in the transform is twice the length of the original frame. The effective length of the input frame is however determined by the length of the non-zero part of wₐ(n). The MDCT spectrum X(m, k) now represents MDCT coefficient k of frame m. The coefficients of the spectrum are partitioned into groups, or bands. These bands are non-uniform in size to mimic the frequency resolution of the human listener, using narrower bands for low frequencies and wider bandwidth for higher frequencies. The energy of each band E(m, b), b=0, 1, . . . , N_{band}−1 is computed according to the formula:

$$E ( m , b ) = \sqrt{\frac{1}{{k}_{end} ( b ) - {k}_{start} ( b ) + 1} {\sum }_{k = {k}_{start} ( b )}^{{k}_{end} ( b )} {X ( m , k )}^{2}}$$

where kₛₜₐᵣₜ(b), . . . , k_{end}(b) denote the indices of band b, and N_{band} is the number of the bands.

The band energies are transformed into log energy indices I(m, b) using the equation:

$$I ( m , b ) = [ 34 - 2 {log}_{2} E ( m , b ) ]$$

and are then quantized to be stored or transmitted to a decoder. Here, [⋅] denotes a rounding operation.

The log energy indices I(m, b) can be seen as the inverted (negative) log energies with a scaling factor applied. The encoder reconstructs the band energies E(m, b)=2^{(34-I(m,b))/2}, which are in turn used to normalize the MDCT spectrum according to the following formula:

$$Y ( m , k ) = \frac{1}{\hat{E} ( m , b )} X ( m , k ) , k = {k}_{start} ( b ) , , {k}_{end} ( b ) , b = 0 , 1 , … , {N}_{band}$$

The normalized spectrum may be encoded using a suitable encoding method such as a vector quantizer (VQ) or a scalar quantizer followed by an entropy coder such as an arithmetic coder. The encoding of the normalized spectrum Y(m, k) is based on a bit allocation R(m, b) which distributes the available bit budget to the bands. The bit allocation is done using a perceptual model which aims to allocate the bits to maximize the perceptual performance. The perceptual model may use the reconstructed spectral envelope Ê(m, b) or equivalently the log energy indices I(m, b) to allocate the bits to the bands. The encoded parameters, including the representations of the log energy indices I(m, b), the normalized spectrum Y(m, k) and information indicating the selected coding mode are combined into a bitstream to be stored or transmitted to a decoder.

### Mode B—ACELP Based Coding Mode

In this mode, the encoding is performed in time domain by means of an Algebraic Code-Excited Linear Prediction (ACELP) coding method. This method relies on a linear predictive analysis to obtain a linear predictor filter Aₘ(z) with coefficients aⱼ, j=0, 1, . . . , M, which represents the spectral envelope of frame m. The coding mode derives a weighting filter Wₘ(z) based on Aₘ(z). Then it searches for the best matching synthesis in the weighted domain by running an encoded excitation signal through the weighted synthesis filter Wₘ(z)/Âₘ(z), where Âₘ(z) is a reconstructed predictor filter. The encoding of the filter coefficients may be done in a domain more suitable for quantization, such as the Line Spectral Frequency (LSF) domain. The encoded parameters, including the representation of Âₘ(z), the encoded excitation signal and information indicating the selected coding mode are combined into a bitstream to be stored or transmitted to a decoder.

### Mode C—MDCT Based Coding Mode 2

This mode is similar to Mode A but has a different structure. For the purpose of this description, it is enough to mention that it does not have the corresponding envelope energies E(m, b) as Mode A has.

### Envelope Stability Measure in Mode A Decoder

The decoder of Mode A produces the log energy indices I(m, b) and the reconstructed normalized spectrum Ŷ(m, k). For the bands b that have received zero bits in the bit allocation R(m, b)=0, a noise-filling algorithm is used. For the low-bitrate bands and the noise-filled bands, an adaptive attenuation is applied. This is done based on an envelope stability measure, denoted as env_stab(m). The envelope stability measure represents changes in the spectrum envelope, including both variation in energy and shape. It may also be called a spectral stability measure. The envelope stability measure is based on the band energies of the current and previous frame determined in accordance with:

$$D ( m ) = \sqrt{\frac{1}{{N}_{bands}} {\sum }_{b = 0}^{{N}_{bands} - 1} {( I ( m , b ) - I ( m - 1 , b ) )}^{2}}$$

The difference is low-pass filtered to form a long-term estimate of the log energy variation.

$${D}_{LP} ( m ) = α D ( m ) + ( 1 - α ) {D}_{LP} ( m - 1 )$$

Here, α is a low-pass filter coefficient where a suitable value may be α=0.1 or in the range α∈[0.01,0.5]. The envelope stability measure env_stab(m) is determined by mapping D_{LP}(m) to the [0,1] range by using a sigmoid function to provide a smooth transition.

$$env\_stab ( m ) = \frac{1}{1 + {e}^{- b ( ( d - {D}_{LP} ( m ) ) + c )}}$$

where the constants b, c, d may be set to b=6.11, c=1.91 and d=2.26.

An alternative expression for this transformation is

$$env\_stab ( m ) = \frac{1}{1 + {e}^{{bD}_{LP} ( m + a )}}$$

where −a/b is the mid point of the transition where env_stab(m)=0.5, and suitable values for the constants a and b may be a=−15.7 and b=6.11, which yields −a/b=2.57

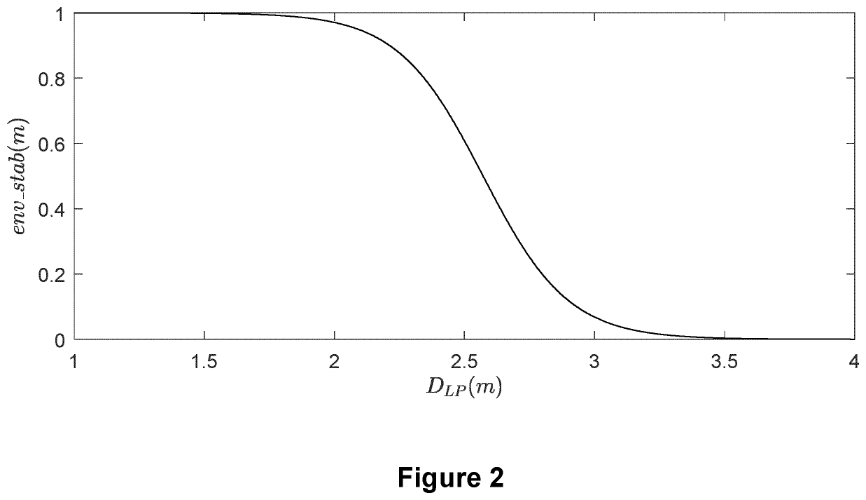

This is a sigmoid function, which can be seen as a soft threshold function with the crossover point at −a/b. A high D_{LP}(m) means the variation is strong, leading to a low env_stab(m). An illustration of this function can be found in FIG. 2.

This function may be discretely sampled which permits the transformation to be implemented by a look-up in a table. It should be noted that the env_stab(m) captures variation in both energy and spectral shape.

### Shape Stability Measure in Mode B

Mode B is a linear predictor based coding mode, where the spectral shape is modeled by a Linear Predictor (LP) filter. The LP filter is represented in Line Spectral Frequency (LSF) domain, which is suitable for quantization and interpolation of the LP filter. A shape stability factor stab_fac(m) is calculated according to

$$stab\_fac ( m ) = 1.25 - \frac{256}{{L}_{ModeB}} \frac{{D}_{LSF} ( m )}{400000}$$

where L_{ModeB} is the frame length of the LP coded band and D_{LSF}(m) is the Euclidian distance between the current frame LSF vector and the previous frame LSF vector. Since stab_fac(m) is based on a difference on the LP filters between the current frame and the previous frame, it captures variations in the spectral shape but excludes variations in energy.

### Multi-Mode Decoder—Mode A

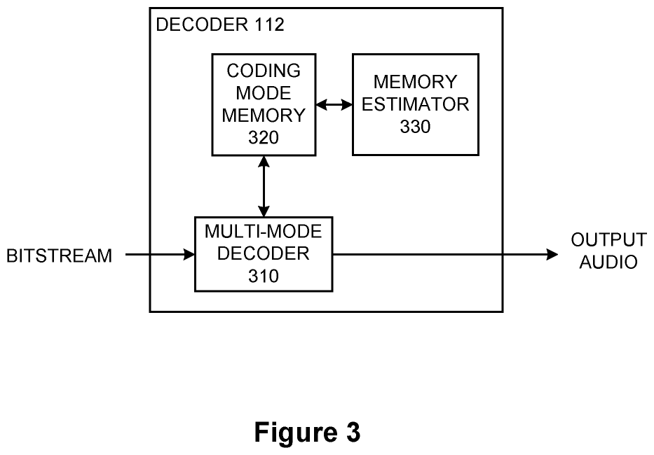

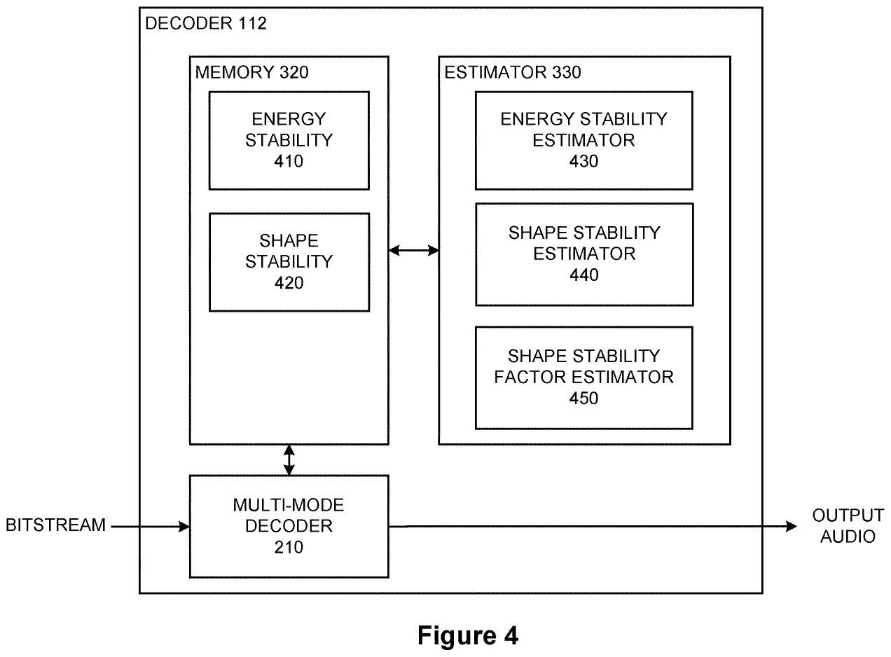

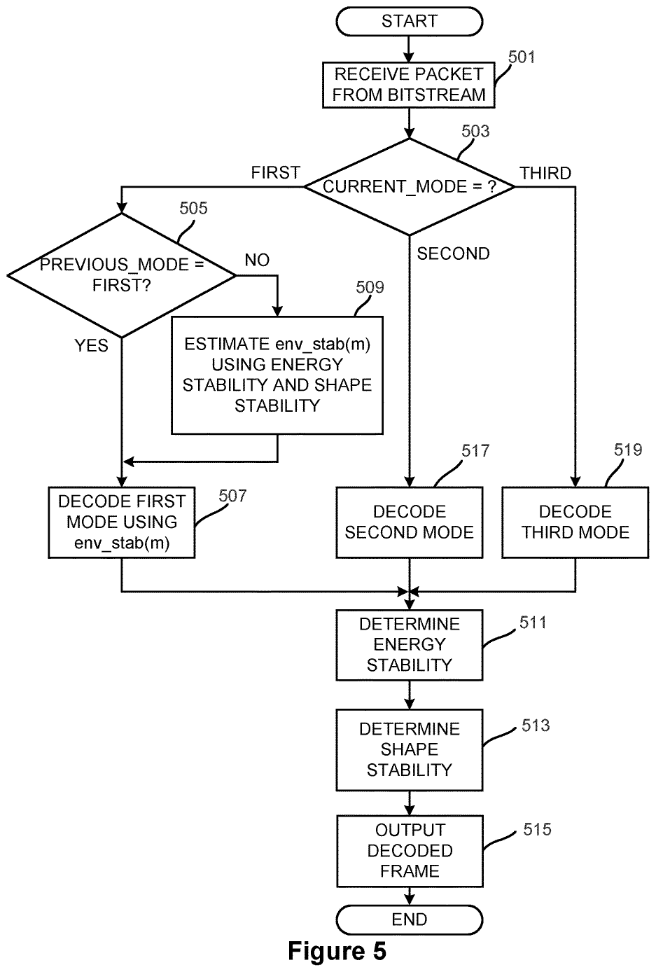

The decoder 112 is illustrated in the block diagram of FIG. 3 and in more detail in FIG. 4, the decoder performs the steps illustrated in FIG. 5 in some embodiments. The decoder has a multi-mode decoder 310 that communicates with coding mode memory 320 that stores variables of past decoded frames such as the log energy indices I(m−1, b), past decoded predictor filter A(z), energy stability E_{Δ,LP}(m−1) 410 and shape stability stab_fac_lt(m−1) 420 of a previous frame during the decoding of encoded audio frames. The estimator 330 estimates the D_{LP}(m) based on the energy stability E_{Δ,LP}(m−1) and shape stability stab_fac_lt(m−1) of the previous frame when the D_{LP}(m−1) is outdated or does not exist using the energy stability estimator 430, the shape stability estimator 440, and the shape stability factor estimator 450.

The multi-mode decoder 310 receives packets from a bitstream representing an encoded audio frame, including information indicating the selected coding mode CURRENT_MODE and the encoded parameters that are required by the multi-mode decoder to perform a reconstruction of the encoded audio frame in block 501. The coding mode of the current frame is needed to select the appropriate decoding method of the frame and is determined in block 503. When the processing of the current frame is completed, the CURRENT_MODE is stored in the variable PREVIOUS_MODE to be used in the following frame. Responsive to the current mode CURRENT_MODE=FIRST (i.e., Mode A), the previous mode is checked in block 505. If the previous mode is also the first mode (e.g., PREVIOUS_MODE=FIRST), the decoder 112 proceeds to decode the current frame in block 507. When decoding the first mode frame, the env_stab(m) is calculated from D_{LP}(m) based on the log energy indices I(m, b) and is used in the decoding. If the previous mode was different from the first mode, PREVIOUS_MODE≠FIRST, the D_{LP}(m) cannot be calculated since D_{LP}(m−1) and I(m−1, b) are outdated or do not exist, since the D_{LP}(m) has not been updated for one or more frames. In this case, the estimator 330, in block 509, estimates the D_{LP}(m) based on the energy stability E_{Δ,LP}(m−1) and shape stability stab_fac_lt(m−1) of the previous frame in accordance with:

$${D}_{LP} ( m ) = {D}_{LP , est} ( m ) = {P}_{1} + {P}_{2} stab\_fac \_lt ( m - 1 ) + {P}_{3} {E}_{Δ , LP} ( m - 1 )$$

where P₁, P₂ and P₃ are constants, stab_fac_lt(m−1) is the shape stability, implemented as the long-term estimate of the shape stability factor from frame m−1 and E_{Δ,LP}(m−1) is the energy stability, implemented as the long-term estimate of the absolute log energy difference between synthesis frames estimated in frame m−1.

Note that the shape stability and energy stability of the previous frame m−1 need to be used since the updated values require that the current frame m is decoded. The constants P₁, P₂ and P₃ may be set experimentally, e.g., using minimum-least-squares approximation to match the D_{LP}(m) based on stab_fac_lt(m) and E_{Δ,LP}(m) for a test database running the first mode (i.e. Mode A) where D_{LP}(m) is available. Another approach would be utilizing machine learning techniques such as a linear regression model using that representative database with cross validation. The coefficients from such model are P₁=2.93, P₂=−2.20 and P₃=0.741. More elaborate mapping functions may also be used, but in general the estimation D_{LP,est}(m) is a function of the energy stability E_{Δ,LP}(m−1) and the shape stability stab_fac_lt(m−1), i.e.,

$${D}_{LP , est} ( m ) = f ( {E}_{Δ , LP} ( m - 1 ) , stab\_fac \_lt ( m - 1 ) )$$

The env_stab(m) is then determined based on D_{LP}(m) as explained earlier.

$$env\_stab ( m ) = \frac{1}{1 + {e}^{{bD}_{LP} ( m ) + a}}$$

The determined energy stability and shape stability are stored in memory 320 together with the other memories of the multi-mode decoder. The decoding of the current first mode then proceeds in block 507 using the estimated env_stab(m) In block 511, the energy stability E_{Δ,LP}(m) is determined. Here, it is defined as the long-term estimate of the absolute log energy difference according to

$${E}_{Δ , LP} ( m ) = β {E}_{Δ} ( m ) + ( 1 - β ) {E}_{Δ , LP} ( m - 1 )$$

$${E}_{Δ} ( m ) = \vert {E}_{log} ( m ) - {E}_{log} ( m - 1 ) \vert$$

$${E}_{log} ( m ) = {log}_{2} \frac{1}{{L}_{out}} {\sum }_{n = 0}^{L - 1} {\hat{x} ( m , n )}^{2}$$

where β is a low-pass filter coefficient, x(m, n) is the output synthesis of frame m and Lₒᵤₜ denotes the output synthesis frame length. It may be identical to the input frame length Lₒᵤₜ=L, but it may also differ from the input if the decoder sampling rate is different from the encoder sampling rate. Note that the factor 1/L_out would be cancelled out in the expression for E_{Δ}(m) and may therefore be omitted.

$${E}_{log}^{′} ( m ) = {log}_{2} {\sum }_{n = 0}^{L - 1} {\hat{x} ( m , n )}^{2}$$

$${E}_{Δ} ( m ) = \vert {E}_{log} ( m ) - {E}_{log} ( m - 1 ) \vert = \vert {E}_{log}^{′} ( m ) - {E}_{log}^{′} ( m - 1 ) \vert$$

In block 513, the shape stability stab_fac_lt(m) is determined. Since an LP filter is not used in the first mode, the shape stability factor stab_fac(m) cannot be calculated based on an LP filter. However, an estimation of the shape stability factor can be determined by the estimator 330 as

$$stab\_fac \_est ( m ) = {Q}_{1} + {Q}_{2} {D}_{LP} ( m ) + {Q}_{3} {E}_{Δ , LP} ( m )$$

where Q₁, Q₂ and Q₃ are constants.

These constants may be set experimentally, e.g. using minimum-least-squares approximation to match stab_fac_est(m) with the true stab_fac(m) based on D_{LP}(m) and E_{Δ,LP}(m) for a test database running the second mode (i.e., Mode B) or the third mode (i.e., Mode C) where stab_fac(m) is available. The estimation can also be done by machine learning approaches such as training a linear regression model using that representative database with cross validation. Suitable values for these constants may be Q₁=1.093 Q₂=−5.84·10⁻⁵ and Q₃=0.125. Note that the result of stab_fac_est(m) may be stored in the same memory location as stab_fac(m) since this memory is otherwise not updated in the first mode. In other words, stab_fac_est(m)=stab_fac(m) in the first mode.

The shape stability is determined by low-pass filtering the estimated shape stability factor.

$$stab\_fac \_lt ( m ) = γ stab\_fac \_est ( m ) + ( 1 - γ ) stab\_fac \_lt ( m - 1 )$$

where γ is a low-pass filter coefficient where a suitable value may be γ=0.1 or in the range γ∈[0.01,0.5]. To clarify, the shape stability is defined as the shape stability factor, low-pass filtered across frames.

Once the multi-mode decoder has completed the decoding of frame m, the synthesized frame is output in block 515 to be played back by the audio player 114 or stored in a decoded format like Pulse Code Modulation (PCM).

### Second Mode (i.e., Mode B) or Third Mode (i.e., Mode C)

If the current mode is identified in block 503 as the second mode, the multi-mode decoder 310 decodes the second mode in block 517. The energy stability E_{Δ,LP}(m) is determined in block 511. Since the second mode is an ACELP based mode, the shape stability factor stab_fac(m) is calculated based on the LP filter and the shape stability is determined in block 513 according to

$$stab\_fac \_lt ( m ) = γ stab\_fac ( m ) + ( 1 - γ ) stab\_fac \_lt ( m - 1 )$$

where γ is a low-pass filter coefficient.

The determined energy stability and shape stability is stored in memory 320 together with the other memories of the multi-mode decoder 310.

If the current mode is identified in block 503 as the third mode, the multi-mode decoder 310 decodes the third mode in block 519 and determines the energy stability E_{Δ,LP}(m) in block 511. The third mode is an MDCT based Mode, but it still uses an LP filter and computes the shape stability factor stab_fac(m). The shape stability is determined in the same manner as it is done for mode B in block 513 as described above.

Once the multi-mode decoder has completed the decoding of frame m, the synthesized frame is output in block 515 to be played back by the audio player 114 or stored in a decoded format like Pulse Code Modulation (PCM).

### Variants of Energy Calculation

The most computationally complex part of the method is the energy calculation which is the basis for the energy stability E_{Δ,LP}(m). It may be beneficial to estimate this energy based on parameters that are already calculated or available in the decoder. For instance, the pitch codebook gain and the innovation codebook gain of the ACELP decoder may be useful to estimate the frame energy. Also, the evolution of these parameters for several frames may be useful. Further, the energy of the ACELP synthesis frame may be found by using an existing calculation of the residual energy together with an estimation of the prediction gain of the LP filter. If an ACELP encoding mode uses a Bandwidth Extension (BWE) scheme, the energy of the BWE region is typically expressed as a ratio relative to the low-band energy of the ACELP encoded band. A synthesis frame energy may also be calculated in a Packet Loss Concealment (PLC) module, which may be reused for this purpose.

FIG. 6 illustrates some other embodiments of performing multi-mode decoding using the decoder 112. Turning to FIG. 6, in block 601, the decoder receives packets from a bitstream representing an encoded audio frame, including information indicating the selected coding mode CURRENT_MODE and the encoded parameters that are required by the multi-mode decoder to perform a reconstruction of the encoded audio frame in block 607. The coding mode of the current frame is needed to select the appropriate decoding method of the frame. When the processing of the current frame is completed, the CURRENT_MODE is stored in the variable PREVIOUS_MODE to be used in the following frame. Responsive to the current mode CURRENT_MODE=FIRST and the previous mode was different from the first mode, PREVIOUS_MODE≠FIRST, the D_{LP}(m−1) and I(m−1, b) are outdated or do not exist, since they have not been updated for one or more frames. In this case, the estimator 330, in block 605, estimates the D_{LP}(m) based on the energy stability E_{Δ,LP}(m−1) and shape stability stab_fac_lt(m−1) of the previous frame as described above and proceeds to block 607 to decode the current frame based on the current mode.

If the determination that the CURRENT_MODE=FIRST and PREVIOUS_MODE≠FIRST is no, the decoder 112 proceeds to decode the current frame in block 607 based on the current mode.

For example, if the current mode is the first mode, the env_stab(m) is calculated from D_{LP}(m) based on the log energy indices I(m, b) and used in the decoding. In block 609, the energy stability E_{Δ,LP}(m) is determined. Here, it is defined as the long-term estimate of the absolute log energy difference according to

$${E}_{Δ , LP} ( m ) = β {E}_{Δ} ( m ) + ( 1 - β ) {E}_{Δ , LP} ( m - 1 )$$

$${E}_{Δ} ( m ) = \vert {E}_{log} ( m ) - {E}_{log} ( m - 1 ) \vert$$

$${E}_{log} ( m ) = {log}_{2} \frac{1}{{L}_{out}} {\sum }_{n = 0}^{L - 1} {\hat{x} ( m , n )}^{2}$$

where \hat{x}(m, n) is the output synthesis frame m and Lₒᵤₜ denotes the output synthesis frame length. It may be identical to the input frame length Lₒᵤₜ=L, but it may also differ from the input if the decoder sampling rate is different from the encoder sampling rate. Note that the factor 1/L_out would be cancelled out in the expression for E_{Δ}(m) and may therefore be omitted.

$${E}_{log}^{′} ( m ) = {log}_{2} {\sum }_{n = 0}^{L - 1} {\hat{x} ( m , n )}^{2}$$

$${E}_{Δ} ( m ) = \vert {E}_{log} ( m ) - {E}_{log} ( m - 1 ) \vert = \vert {E}_{log}^{′} ( m ) - {E}_{log}^{′} ( m - 1 ) \vert$$

In block 611, the shape stability stab_fac_lt(m) is determined. Since an LP filter is not used in the first mode, the stability factor stab_fac(m) cannot be calculated based on an LP filter. However, an estimation of the stability factor can be estimated by the estimator 330 as

$$stab\_fac \_est ( m ) = {Q}_{1} + {Q}_{2} {D}_{LP} ( m ) + {Q}_{3} {E}_{Δ , LP} ( m )$$

where Q₁, Q₂ and Q₃ are constants.

These may be set experimentally, e.g. using minimum-least-squares approximation to match stab_fac_est(m) with the true stab_fac(m) based on D_{LP}(m) and E_{Δ,LP}(m) for a test database running the second mode or the third mode where stab_fac(m) is available. The estimation can also be done by machine learning approaches such as training a linear regression model using that representative database with e.g., 5-fold cross validation. Suitable values for these constants may be Q₁=1.093 Q₂=−5.84·10⁻⁵ and Q₃=0.125. Note that the result of stab_fac_est(m) may be stored in the same memory location as stab_fac(m) since this memory is otherwise not updated in the first mode. In other words, stab_fac_est(m)=stab_fac(m) in the first mode.

The shape stability is determined by low-pass filtering the estimated stability factor.

$$stab\_fac \_lt ( m ) = γ stab\_fac \_est ( m ) + ( 1 - γ ) stab\_fac \_lt ( m - 1 )$$

where γ is a low-pass filter coefficient where a suitable value may be γ=0.1 or in the range γ∈[0.01,0.5]. In other words, the shape stability is defined as the stability factor, low-pass filtered across frames.

If the current mode is the second mode or the third mode, the shape stability is determined in block 611 according to

$$stab\_fac \_lt ( m ) = γ stab\_fac ( m ) + ( 1 - γ ) stab\_fac \_lt ( m - 1 )$$

where γ is a low-pass filter coefficient. In block 613, a decoded frame is output.

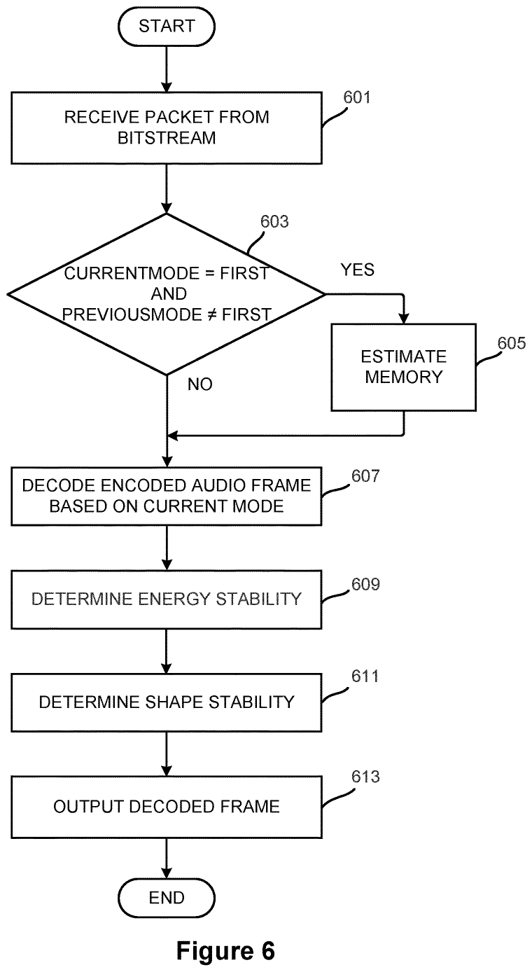

FIG. 7 shows an audio decoder 112 (e.g., a decoder) in accordance with some embodiments where the audio decoder 112 is implemented as a stand-alone device. As used herein, an audio decoder refers to a device capable, configured, arranged and/or operable to decode encoded objects and communicate with network nodes, encoders, and/or decoders. Examples of an audio decoder include, but are not limited to, a smart phone, mobile phone, cell phone, voice over IP (VoIP) phone, wireless local loop phone, desktop computer, personal digital assistant (PDA), wireless cameras, gaming console or device, storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc.

An audio decoder may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a decoder may not necessarily have a user in the sense of a human user who owns and/or operates the relevant device.

The audio decoder 112 includes processing circuitry 702 that is operatively coupled via a bus 704 to an input/output interface 706, a power source 708, a memory 710, a communication interface 712, and/or any other component, or any combination thereof. Certain decoders may utilize all or a subset of the components shown in FIG. 7. The level of integration between the components may vary from one decoder to another decoder. Further, certain decoders may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, an actuator, an emitter, a smartcard, another output device, or any combination thereof. An input device may allow a user to capture information into the audio decoder 112. Examples of an input device include a touch-sensitive or presence-sensitive display, a camera (e.g., a digital camera, a digital video camera, a web camera, etc.), a microphone, a sensor, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the audio decoder 112 via input circuitry or an interface such as an electrical power cable. Delivering power may be, for example, for charging of the power source 708. Power circuitry may perform any formatting, converting, or other modification to the power from the power source 708 to make the power suitable for the respective components of the audio decoder 112 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the audio decoder 112, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the audio decoder 112 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, an audio decoder may provide an output of decoded data, through its communication interface 712, via a wireless connection to a network node.

An audio decoder when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a thermostat, an electrical door lock, a connected doorbell, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement. A decoder in the form of an IoT device comprises circuitry and/or software in dependence of the intended application of the IoT device in addition to other components as described in relation to the audio decoder 112 shown in FIG. 7.

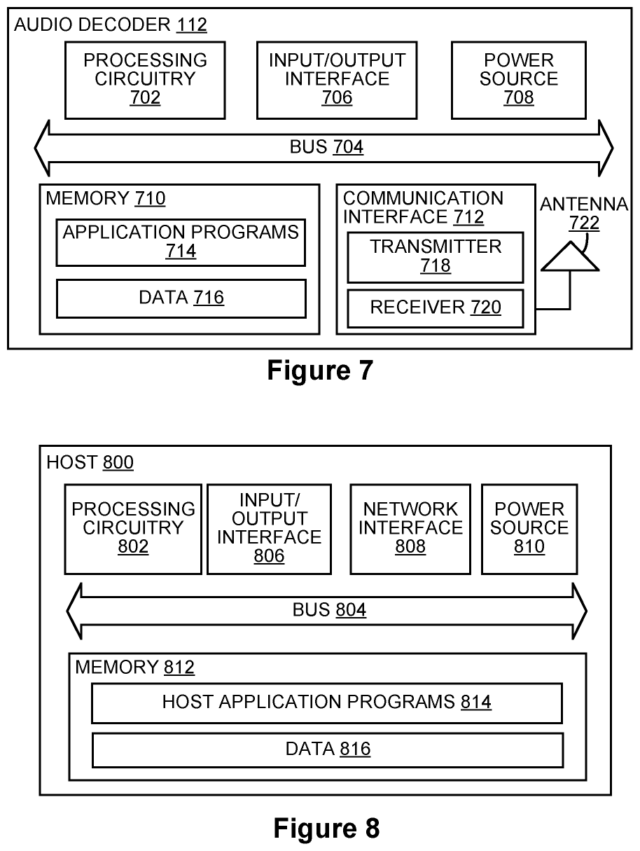

FIG. 8 is a block diagram of a host 800 in accordance with various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIG. 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711, EVS, IVAS), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

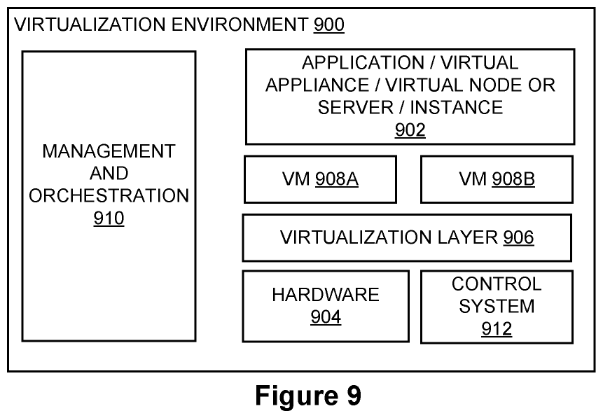

FIG. 9 is a block diagram illustrating a virtualization environment 900 in which functions implemented by some embodiments of the audio decoder 112 or components of the audio decoder 112 may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a decoder, encoder, network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908A and 908B (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g., such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

Although the computing devices described herein (e.g., decoders, encoders, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

### EXAMPLE EMBODIMENTS

1. A method in a decoder (112, 902) to decode an encoded audio encoded using at least two modes, the method comprising:
receiving (501) a packet from a bitstream representing an encoded audio frame, the packet including information indicating a selected coding mode and encoded parameters required to perform a reconstruction of the encoded audio frame;
determining (503) whether the selected coding mode is a first mode;
responsive to determining that the selected coding mode is the first mode, determining (505) whether a previous coding mode is the first mode;
responsive to the selected coding mode being the first mode and the previous coding mode not being the first mode, estimating (509) an envelope stability measure using an energy stability and a shape stability and using the estimated envelope stability measure as the envelope stability measure;
decoding (507) the encoded audio frame using the envelope stability measure;
determining (511) an energy stability;
determining (513) a shape stability; and
outputting (515) the decoded audio frame to one of storage and an audio playback device.
   2. The method of Embodiment 1, further comprising:
responsive to the selected coding mode being the first mode and the previous coding mode being the first mode, determining an envelope stability measure as part of decoding the first mode of the encoded audio frame.
   3. The method of any of Embodiments 1-2, further comprising responsive to determining that the selected coding mode is a second mode based on Algebraic Code-Excited Linear Prediction (ACELP), decoding (517) the encoded audio frame using an ACELP based coding mode.
   4. The method of any of Embodiments 1-3, further comprising responsive to determining that the selected coding mode is a third mode based on Modified Discrete Cosine Transform (MDCT) coding, decoding (519) the encoded audio frame using MDCT based coding.
   5. The method of any of Embodiments 1-2, wherein determining the envelope stability env_stab(m) comprises:
determining a long-term estimate of a log energy variation. D_{LP}(m);
deriving the env_stab(m) by mapping the long-term estimate of the log energy variation to a [0,1] range.
   6. The method of Embodiment 5, wherein estimating the long-term estimate of the log energy variation comprises determining D_{LP}(m) in accordance with:

$$D ( m ) = \sqrt{\frac{1}{{N}_{bands}} {\sum }_{b = 0}^{{N}_{bands} - 1} {( I ( m , b ) - I ( m - 1 , b ) )}^{2}}$$

$${D}_{LP} ( m ) = α D ( m ) + ( 1 - α ) {D}_{LP} ( m - 1 )$$

where N_{bands} is a number of energy bands, I(m, b) and I(m−1, b) are log energy indices, and α is a low-pass filter coefficient.
7. The method of any of Embodiments 5-6, wherein deriving the env_stab(m) comprises deriving the env_stab(m) in accordance with

$$env\_stab ( m ) = \frac{1}{1 + {e}^{- b ( ( d - {D}_{LP} ( m ) ) + c )}}$$

where b, c, and d are constants.
8. The method of Embodiment 5, wherein estimating the long-term estimate of the log energy variation comprises determining D_{LP}(m) in accordance with:

$${D}_{LP} ( m ) = {D}_{LP , est} ( m ) = {P}_{1} + {P}_{2} stab\_fac \_lt ( m - 1 ) + {P}_{3} {E}_{Δ , LP} ( m - 1 )$$

where P₁, P₂ and P₃ are constants, stab_fac_lt(m−1) is a shape stability from frame m−1 and E_{Δ,LP}(m−1) is an energy stability from frame m−1.
9. The method of Embodiment 8, wherein deriving the env_stab(m) comprises deriving the env_stab(m) in accordance with

$$env\_stab ( m ) = \frac{1}{1 + {e}^{{bD}_{LP} ( m ) + a}}$$

where −a/b is a mid point of the transition where env_stab(m)=0.5
10. The method of any of Embodiments 1-9, wherein determining the energy stability E_{Δ,LP}(m) is a long-term estimate of the absolute log energy difference between synthesis frames derived in accordance with:

$${E}_{Δ , LP} ( m ) = β {E}_{Δ} ( m ) + ( 1 - β ) {E}_{Δ , LP} ( m - 1 )$$

$${E}_{Δ} ( m ) = \vert {E}_{l o g} ( m ) - {E}_{l o g} ( m - 1 ) \vert$$

$${E}_{l o g} ( m ) = {log}_{2} \frac{1}{{L}_{out}} {\sum }_{n = 0}^{L - 1} {\hat{x} ( m , n )}^{2}$$

where \hat{x}(m, n) is an output synthesis frame m and Lₒᵤₜ denotes an output synthesis frame length.
11. The method of any of Embodiments 1-9, wherein determining the energy stability E_{Δ,LP}(m) comprises determining E_{Δ,LP}(m) in accordance with:

$${E}_{Δ , LP} ( m ) = β {E}_{Δ} ( m ) + ( 1 - β ) {E}_{Δ , LP} ( m - 1 )$$

$${E}_{Δ} ( m ) = \vert {E}_{log}^{′} ( m ) - {E}_{log}^{′} ( m - 1 ) \vert$$

$${E}_{log}^{′} ( m ) = {log}_{2} {\sum }_{n = 0}^{L - 1} {\hat{x} ( m , n )}^{2}$$

12. The method of Embodiment 1, wherein determining the shape stability stab_fac_lt(m) comprises determining stab_fac_lt(m) in accordance with

$$stab\_fac \_lt ( m ) = γstab\_fac \_est ( m ) + ( 1 - γ ) stab\_fac \_lt ( m - 1 )$$

$$stab\_fac \_est ( m ) = {Q}_{1} + {Q}_{2} {D}_{LP} ( m ) + {Q}_{3} {E}_{Δ , LP} ( m )$$

where γ is a low-pass filter coefficient, Q₁, Q₂ and Q₃ are constants, D_{LP}(m) is a long-term estimate of a log energy variation, and E_{Δ,LP}(m) is a long-term estimate of the absolute log energy difference between synthesis frames.
13. The method of any of Embodiments 1-12 wherein the first mode is a modified discrete cosine transform (MDCT) based coding mode.
14. The method of any of Embodiments 3-4 wherein determining the shape stability, stab_fac_lt(m) comprises determining stab_fac_lt(m) in accordance with

$$stab\_fac \_lt ( m ) = γstab\_fac ( m ) + ( 1 - γ ) stab\_fac \_lt ( m - 1 )$$

where γ is a low-pass filter coefficient and stab_fac(m) is a shape stability factor based on an Euclidian distance between a Line Spectral Frequency (LSF) representation of a Linear Predictor (LP) filter of the current frame and the previous frame.
15. A method in a decoder (112, 902) to decode an encoded audio encoded using multiple modes, the method comprising:
receiving (601) a packet from a bitstream representing an encoded audio frame, the packet including information indicating a selected coding mode and encoded parameters required to perform a reconstruction of the encoded audio frame;
determining (603) whether a current mode is a first mode and a previous mode is not the first mode;
responsive to the determining being yes, estimating (605) an envelope stability measure using an energy stability and a shape stability;
decoding (607) the encoded audio frame based on the current mode;
determining (609) an energy stability;
determining (611) a shape stability; and
outputting (613) a decoded audio frame.
   16. The method of Embodiment 15, wherein determining (603) whether a current mode is a first mode and a previous mode is not the first mode;
responsive to the determining being no, determining an envelope stability measure as part of the decoding of the first mode 607.
   17. The method of Embodiment 15, wherein decoding the encoded audio frame based on the current mode comprises responsive to determining that the selected coding mode is a second mode based on Algebraic Code-Excited Linear Prediction (ACELP), decoding the encoded audio frame using ACELP decoding.
   18. The method of any of Embodiments 15-17, wherein decoding the encoded audio frame based on the current mode comprises responsive to determining that the selected coding mode is a third mode based on MDCT, decoding (519) the encoded audio frame using MDCT based decoding.
   19. The method of Embodiment 15, wherein determining the env_stab(m) comprises: determining a long-term estimate of a log energy variation. D_{LP}(m);
deriving the env_stab(m) by mapping the long-term estimate of the log energy variation to a [0,1] range.
   20. The method of Embodiment 19, wherein determining the long-term estimate of the log energy variation comprises determining D_{LP}(m) in accordance with:

$$D ( m ) = \sqrt{\frac{1}{{N}_{bands}} {\sum }_{b = 0}^{{N}_{bands} - 1} {( I ( m , b ) - I ( m - 1 , b ) )}^{2}}$$

$${D}_{LP} ( m ) = α D ( m ) + ( 1 - α ) {D}_{LP} ( m - 1 )$$

where N_{bands} is a number of energy bands, I(m, b) and I(m−1, b) are log energy indices, and α is a low-pass filter coefficient.
21. The method of any of Embodiments 19-20, wherein deriving env_stab(m) comprises deriving env_stab(m) in accordance with

$$env\_stab ( m ) = \frac{1}{1 + {e}^{- b ( ( d - {D}_{L P} ( m ) ) + c )}}$$

where b, c, and d are constants.
22. The method of any of Embodiments 19-21, wherein estimating the long-term estimate of the log energy variation comprises estimating D_{LP}(m) in accordance with:

$${D}_{LP} ( m ) = {D}_{L P , est} ( m ) = {P}_{1} + {P}_{2} stab\_fac \_lt ( m - 1 ) + {P}_{3} {E}_{Δ , LP} ( m - 1 )$$

where P₁, P₂ and P₃ are constants, stab_fac_lt(m−1) is a shape stability from frame m−1 and E_{Δ,LP}(m−1) is a long-term estimate of the absolute log energy difference between synthesis frames.
23. The method of Embodiment 19-20, wherein deriving env_stab(m) comprises deriving env_stab(m) in accordance with

$$e n {v}_{stab ( m )} = \frac{1}{1 + {e}^{{bD}_{LP} ( m ) + a}}$$

where −a/b is a mid point of the transition where env_stab(m)=0.5
24. The method of any of Embodiments 15-23, wherein determining the energy stability E_{Δ,LP}(m) comprises determining E_{Δ,LP}(m) in accordance with:

$${E}_{Δ , LP} ( m ) = β {E}_{Δ} ( m ) + ( 1 - β ) {E}_{Δ , LP} ( m - 1 )$$

$${E}_{Δ} ( m ) = \vert {E}_{l o g} ( m ) - {E}_{l o g} ( m - 1 ) \vert$$

$${E}_{l o g} ( m ) = {log}_{2} \frac{1}{{L}_{out}} {\sum }_{n = 0}^{L - 1} {\hat{x} ( m , n )}^{2}$$

where \hat{x}(m, n) is an output synthesis frame m and Lₒᵤₜ denotes an output synthesis frame length.
25. The method of any of Embodiments 15-23, wherein determining the energy stability E_{Δ,LP}(m) comprises determining E_{Δ,LP}(m) in accordance with:

$${E}_{Δ , LP} ( m ) = β {E}_{Δ} ( m ) + ( 1 - β ) {E}_{Δ , LP} ( m - 1 )$$

$${E}_{Δ} ( m ) = \vert {E}_{log}^{′} ( m ) - {E}_{log}^{′} ( m - 1 ) \vert$$

$${E}_{log}^{′} ( m ) = {log}_{2} {\sum }_{n = 0}^{L - 1} {\hat{x} ( m , n )}^{2}$$

26. The method of Embodiment 15, wherein determining the shape stability stab_fac_lt(m) comprises determining stab_fac_lt(m) for a first mode in accordance with

$$stab\_fac \_lt ( m ) = γstab\_fac \_est ( m ) + ( 1 - γ ) stab\_fac \_lt ( m - 1 )$$

$$stab\_fac \_est ( m ) = {Q}_{1} + {Q}_{2} {D}_{LP} ( m ) + {Q}_{3} {E}_{Δ , LP} ( m )$$

where γ is a low-pass filter coefficient, Q₁, Q₂ and Q₃ are constants, D_{LP}(m) is a long-term estimate of a log energy variation, and E_{Δ,LP}(m) is a long-term estimate of the absolute log energy difference between synthesis frames.
27. The method of any of Embodiments 15-26 wherein the first mode is a modified discrete cosine transform (MDCT) based coding mode.
28. The method of any of Embodiments 15-27 wherein determining the shape stability, stab_fac_lt(m) comprises determining stab_fac_lt(m) for the second mode and the third mode in accordance with

$$stab\_fac \_lt ( m ) = γstab\_fac ( m ) + ( 1 - γ ) stab\_fac \_lt ( m - 1 )$$

where γ is a low-pass filter coefficient.
29. A decoder (112, 902) to decode an encoded audio encoded using multiple modes the decoder adapted to perform in accordance with any of Embodiments 1-28.
30. A decoder (112, 902) to decode an encoded audio encoded using multiple modes, the decoder (112) comprising:
processing circuitry (702);
memory (710) coupled with the processing circuitry, wherein the memory includes instructions that when executed by the processing circuitry causes the decoder to perform operations in accordance with any of Embodiments 1-28.
   31. A computer program comprising program code to be executed by processing circuitry (702) of a decoder (112, 902), whereby execution of the program code causes the decoder (112, 902) to perform operations in accordance with any of Embodiments 1-28.
   32. A computer program product comprising a non-transitory storage medium including program code to be executed by processing circuitry (702) of a decoder (112, 902), whereby execution of the program code causes the decoder (112, 902) to perform operations in accordance with any of Embodiments 1-28.

1. A method in a decoder to decode an encoded audio frame, the audio frame being encoded using one of at least two modes, the method comprising:
receiving information indicating a selected coding mode;
determining whether the selected coding mode is a first mode;
responsive to determining that the selected coding mode is the first mode, determining whether a previous coding mode is the first mode;
responsive to the selected coding mode being the first mode and the previous coding mode not being the first mode, estimating an envelope stability measure using an energy stability and a shape stability of a previous frame;
decoding the encoded audio frame using the estimated envelope stability measure;
determining an energy stability of a current frame; and
determining a shape stability of a current frame.

2. The method of claim 1, further comprising:
responsive to the selected coding mode being the first mode and the previous coding mode being the first mode, determining an envelope stability measure as part of decoding the first mode of the encoded audio frame.

3. The method of claim 1, further comprising responsive to determining that the selected coding mode is a second mode based on Algebraic Code-Excited Linear Prediction (ACELP), decoding the encoded audio frame using an ACELP based coding mode.

4. The method of claim 1, further comprising responsive to determining that the selected coding mode is a third mode based on Modified Discrete Cosine Transform (MDCT) coding, decoding the encoded audio frame using MDCT based coding.

5. The method of claim 1, wherein determining the envelope stability measure env_stab(m) comprises:
determining a long-term estimate of a log energy variation D_{LP}(m);
determining the env_stab(m) by mapping the long-term estimate of the log energy variation to a [0,1] range.

6. The method of claim 5, wherein determining the long-term estimate of the log energy variation comprises determining D_{LP}(m) in accordance with:
$$D ( m ) = \sqrt{\frac{1}{{N}_{bands}} {\sum }_{b = 0}^{{N}_{bands} - 1} {( I ( m , b ) - I ( m - 1 , b ) )}^{2}}$$
$${D}_{LP} ( m ) = α D ( m ) + ( 1 - α ) {D}_{LP} ( m - 1 )$$
where N_{bands} is a number of energy bands, I(m, b) and I(m−1, b) are log energy indices of the current and previous frame, and a is a low-pass filter coefficient.

7. The method of claim 5, wherein determining the env_stab(m) comprises determining the env_stab(m) in accordance with
$$env\_stab ( m ) = \frac{1}{1 + {e}^{- b ( ( d - {D}_{LP} ( m ) ) + c )}}$$
where b, c, and d are constants.

8. The method of claim 5, wherein determining the long-term estimate of the log energy variation comprises determining D_{LP}(m) in accordance with:
$${D}_{LP} ( m ) = {D}_{LP , est} ( m ) = {P}_{1} + {P}_{2} stab\_fac \_lt ( m - 1 ) + {P}_{3} {E}_{Δ , LP} ( m - 1 )$$
where P₁, P₂ and P₃ are constants, stab_fac_lt(m−1) is a shape stability from frame m−1 and E_{Δ,LP}(m−1) is an energy stability from frame m−1.

9. The method of claim 8, wherein determining the env_stab(m) comprises determining the env_stab(m) in accordance with
$$env\_stab ( m ) = \frac{1}{1 + {e}^{{bD}_{LP , est} ( m ) + a}}$$
where −a/b is a mid point of the transition where env_stab(m)=0.5.

10. The method of claim 1, wherein determining the energy stability E_{Δ,LP}(m) comprises determining E_{Δ,LP}(m) in accordance with:
$${E}_{Δ f P} ( m ) = β {E}_{Δ} ( m ) + ( 1 - β ) {E}_{Δ , LP} ( m - 1 )$$
$${E}_{Δ} ( m ) = \vert {E}_{l o g} ( m ) - {E}_{l o g} ( m - 1 ) \vert$$
$${E}_{l o g} ( m ) = {log}_{2} \frac{1}{{L}_{o u f}} {\sum }_{n = 0}^{L - 1} {\hat{x} ( m , n )}^{2}$$
where \hat{x}(m, n) is an output synthesis frame m comprising samples n=0, . . . L−1, Lₒᵤₜ denotes an output synthesis frame length and β is a low-pass filter coefficient.

11. The method of claim 1, wherein determining the energy stability E_{Δ,LP}(m) comprises determining E_{Δ,LP}(m) in accordance with:
$${E}_{Δ , LP} ( m ) = β {E}_{Δ} ( m ) + ( 1 - β ) {E}_{Δ , LP} ( m - 1 )$$
$${E}_{Δ} ( m ) = \vert {E}_{log}^{′} ( m ) - {E}_{log}^{′} ( m - 1 ) \vert$$
$${{E}_{log}^{′}}_{} ( m ) = {log}_{2} {\sum }_{n = 0}^{L - 1} {\hat{x} ( m , n )}^{2}$$
where \hat{x}(m, n) is an output synthesis frame m comprising samples n=0, . . . L−1 and β is a low-pass filter coefficient.

12. The method of claim 1, wherein determining the shape stability stab_fac_lt(m) comprises determining stab_fac_lt(m) in accordance with
$$stab\_fac \_lt ( m ) = γstab\_fac \_est ( m ) + ( 1 - γ ) stab\_fac \_lt ( m - 1 )$$
$$stab\_fac \_est ( m ) = {Q}_{1} + {Q}_{2} {D}_{LP} ( m ) + {Q}_{3} {E}_{Δ , LP} ( m )$$
where γ is a low-pass filter coefficient, stab_fac_est(m) is an estimation of the shape stability factor, Q₁, Q₂ and Q₃ are constants, D_{LP}(m) is a long-term estimate of a log energy variation, and E_{Δ,LP}(m) is the energy stability.

13. The method of claim 1, wherein the first mode is a modified discrete cosine transform (MDCT) based coding mode.

14. The method of claim 3, wherein determining the shape stability, stab_fac_lt(m) comprises determining stab_fac_lt(m) in accordance with
$$stab\_fac \_lt ( m ) = γstab\_fac ( m ) + ( 1 - γ ) stab\_fac \_lt ( m - 1 )$$
where γ is a low-pass filter coefficient and stab_fac(m) is a shape stability factor based on an Euclidian distance between a Line Spectral Frequency (LSF) representation of a Linear Predictor (LP) filter of the current frame and the previous frame.

15-32. (canceled)

33. A decoder to decode an encoded audio frame, the audio frame being encoded using one of at least two modes, the decoder being configured to:
receive information indicating a selected coding mode;
determine whether the selected coding mode is a first mode;
responsive to determining that the selected coding mode is the first mode, determine whether a previous coding mode is the first mode;
responsive to the selected coding mode being the first mode and the previous coding mode not being the first mode, estimate an envelope stability measure using an energy stability and a shape stability of a previous frame;
decode the encoded audio frame using the estimated envelope stability measure;
determine an energy stability of a current frame; and
determine a shape stability of a current frame.

34. The decoder of claim 33, further being configured to:
responsive to the selected coding mode being the first mode and the previous coding mode being the first mode, determine an envelope stability measure as part of decoding the first mode of the encoded audio frame.

35. The decoder of claim 33, further being configured to decode the encoded audio frame using an ACELP based coding mode responsive to determining that the selected coding mode is a second mode based on Algebraic Code-Excited Linear Prediction (ACELP).

36. The decoder of claim 33, further being configured to decode the encoded audio frame using MDCT based coding responsive to determining that the selected coding mode is a third mode based on Modified Discrete Cosine Transform (MDCT) coding.

37. The decoder of claim 33, wherein determining the envelope stability measure env_stab(m) comprises:
determining a long-term estimate of a log energy variation D_{LP}(m);
determining the env_stab(m) by mapping the long-term estimate of the log energy variation to a [0,1] range.

38. The decoder of claim 37, wherein determining the long-term estimate of the log energy variation comprises determining D_{LP}(m) in accordance with:
$$D ( m ) = \sqrt{\frac{1}{{N}_{bands}} {\sum }_{b = 0}^{{N}_{bands} - 1} {( I ( m , b ) - I ( m - 1 , b ) )}^{2}}$$
$${D}_{LP} ( m ) = α D ( m ) + ( 1 - α ) {D}_{LP} ( m - 1 )$$
where N_{bands} is a number of energy bands, I(m, b) and I(m−1, b) are log energy indices of the current and previous frame, and a is a low-pass filter coefficient.

39. The decoder of claim 37, wherein determining the env_stab(m) comprises determining the env_stab(m) in accordance with
$$env\_stab ( m ) = \frac{1}{1 + {e}^{- b ( ( d - {D}_{LP} ( m ) ) + c )}}$$
where b, c, and d are constants.

40. The decoder of claim 37, wherein determining the long-term estimate of the log energy variation comprises determining D_{LP}(m) in accordance with:
$${D}_{LP} ( m ) = {D}_{LP , est} ( m ) = {P}_{1} + {P}_{2} stab\_fac \_lt ( m - 1 ) + {P}_{3} {E}_{Δ , LP} ( m - 1 )$$
where P₁, P₂ and P₃ are constants, stab_fac_lt(m−1) is a shape stability from frame m−1 and E_{Δ,LP}(m−1) is an energy stability from frame m−1.

41. The decoder of claim 40, wherein determining the env_stab(m) comprises determining the env_stab(m) in accordance with
$$env\_stab ( m ) = \frac{1}{1 + {e}^{{bD}_{LP , est} ( m ) + a}}$$
where −a/b is a mid point of the transition where env_stab(m)=0.5

42. The decoder of claim 33, wherein determining the energy stability E_{Δ,LP} (m) comprises determining E_{Δ,LP}(m) in accordance with:
$${E}_{Δ , LP} ( m ) = β {E}_{Δ} ( m ) + ( 1 - β ) {E}_{Δ , LP} ( m - 1 )$$
$${E}_{Δ} ( m ) = \vert {E}_{log} ( m ) - {E}_{log} ( m - 1 ) \vert$$
$${E}_{log} ( m ) = {log}_{2} \frac{1}{{L}_{out}} {\sum }_{n = 0}^{L - 1} {\hat{x} ( m , n )}^{2}$$
where \hat{x}(m, n) is an output synthesis frame m comprising samples n=0, . . . L−1, Lₒᵤₜ denotes an output synthesis frame length and β is a low-pass filter coefficient.

43. The decoder of claim 33, wherein determining the energy stability E_{Δ,LP}(m) comprises determining E_{Δ,LP}(m) in accordance with:
$${E}_{Δ , LP} ( m ) = β {E}_{Δ} ( m ) + ( 1 - β ) {E}_{Δ , LP} ( m - 1 )$$
$${E}_{Δ} ( m ) = \vert {E}_{log}^{′} ( m ) - {E}_{log}^{′} ( m - 1 ) \vert$$
$${{E}_{log}^{′}}_{} ( m ) = {log}_{2} {\sum }_{n = 0}^{L - 1} {\hat{x} ( m , n )}^{2}$$
where \hat{x}(m, n) is an output synthesis frame m comprising samples n=0, . . . L−1 and β is a low-pass filter coefficient.

44. The decoder of claim 33, wherein determining the shape stability stab_fac_lt(m) comprises determining stab_fac_lt(m) in accordance with
$$stab\_fac \_lt ( m ) = γstab\_fac \_est ( m ) + ( 1 - γ ) stab\_fac \_lt ( m - 1 )$$
$$stab\_fac \_est ( m ) = {Q}_{1} + {Q}_{2} {D}_{LP} ( m ) + {Q}_{3} {E}_{Δ , LP} ( m )$$
where γ is a low-pass filter coefficient, stab_fac_est(m) is an estimation of the shape stability factor, Q₁, Q₂ and Q₃ are constants, D_{LP}(m) is a long-term estimate of a log energy variation, and E_{Δ,LP}(m) is the energy stability.

45-46. (canceled)
